(19) United States
(12) Patent Application Publication
(10) Pub. No.: US 2005/0054326 A1
(43) Pub. Date: Mar. 10, 2005

(54) Method and system for securing and monitoring a wireless network

(76) Inventor: Todd Rogers, Austin, TX (US)

Correspondence Address: DILLON & YUDELL LLP, 8911 NORTH CAPITAL OF TEXAS HWY, SUITE 2110, AUSTIN, TX, 78759, US

(21) Appl. No.: 10/936,103

(22) Filed: Sep. 8, 2004

Related U.S. Application Data
(60) Provisional application No. 60/501,531, filed on Sep. 9, 2003.
(60) Provisional application No. 60/557,822, filed on Mar. 30, 2004.

(51) Int. Cl. H04L 9/00

(52) U.S. Cl. 455/410; 370/389; 713/201

(57) ABSTRACT

A common software interface simplifies a process of configuring the network security features provided by network controlled devices. A real-time threat entity detection system automatically scans the network using various protocols and builds entity profile data for each detection. The entity profile data is saved and updated every time the entity is detected on the network. Once the scan is complete, the system user is prompted to classify each newly detected node as a member or non-member of the network. The system user can then define automatic actions to take upon identification of the existence of the defined threat entity on the network at any point in the future. For example, a typical action could include notifying the threat entity of its detection or sending continuous requests to the threat entity over the network to effectively eliminate the usefulness of its membership on the network. The software also contacts the network gateway or router and configures MAC address filtering and disables broadcast of the router's SSID, effectively making the network invisible to any devices other than the devices allowed on the network. Additionally, the solution provides a process to add new members to the network while security features are enabled.

### PRIORITY CLAIM

The application claims the benefit of priority under 35 U.S.C. §119(e) from U.S. Provisional Application No. 60/501,531, entitled, “Method And System For Threat Entity Detection In A Wireless Network,” filed on Sep. 9, 2003, and U.S. Provisional Application No. 60/557,822, entitled, “Method and system for enabling security settings on a remote router,” filed on Mar. 30, 2004, which disclosures are incorporated herein by reference.

### BACKGROUND OF THE INVENTION

1. Field of the Invention

The present invention is directed to systems and methods for enhancing security associated with wireless communications. More specifically, the present invention relates to computer-based systems and methods for assessing security risks and identifying and responding to threats in wireless network environments.

2. Description of Related Art

As computer networks have become more widely used, they have also created new risks for individuals and corporations. Breaches of computer security by hackers and intruders and the potential for compromising sensitive information are very real and a serious threat. This problem has become even more difficult to contain with the rapid growth in the use of wireless networking equipment.

Wireless Local Area Networks (WLANs) offer a quick and effective extension of a wired network or standard local area network (LAN), but unauthorized access to these networks behind a firewall has become a common concern, especially within home or business wireless networks. Unauthorized access can leave all client computers within the network exposed to threats from the unauthorized entity. Unauthorized access can also lead to the network being used for purposes other than originally intended. Identifying threat entities and taking corrective action is important in mitigating these risks.

Currently, the security responsibility of the network in relation to wireless members is relegated to the wireless access point providing the network membership or the router responsible for all nodes on the given wireless segment. These devices typically contain software to encrypt traffic on the network, as well as software to deny access to the network based on a number of techniques including MAC address filtering and password protection access. Additionally, these devices can suppress the broadcast of their availability on the network, effectively hiding their presence.

These methodologies currently in use are effective for denying access to threat entities, but most manufacturers of wireless network equipment provide equipment with these features disabled by default. Furthermore, lack of consumer awareness of the features coupled with a general lack of understanding of network security insures that the majority of wireless equipment purchased for the home and business markets will be deployed without these features enabled. Moreover, given the nature of these markets, users will remain unaware or unwilling to enable many of these features in their activated wireless network systems.

To be able to detect possible threat entity membership on a network, there is a need for real-time intrusion detection. There is a need to automatically catalog data specific for each entity that can be used to determine if the entity is a threat. There is a need for the system to notify the system user of a new threat detection and alternatively attempt to notify the threat entity. There is also a need for automatic notification to the threat entity after it has been identified as a threat. There is further a need for a simplified universal interface to control available security measures provided in wireless networking equipment to permit end users to simply and efficiently control the process of securing the wireless network, and to provide control of other enhanced security features on the wireless network.

### SUMMARY OF THE INVENTION

In accordance with the present invention, improved methods, systems and articles of manufacture for threat entity detection in a wireless network is disclosed. In one embodiment of the present invention, a method includes detecting entities accessing a wireless network, identifying a detected entity is unauthorized on the wireless network, and enabling security settings within an access point to the wireless network to restrict the unauthorized entity's access to the wireless network.

All objects, features, and advantages of the present invention will become apparent in the following detailed written description.

### BRIEF DESCRIPTION OF DRAWINGS

This invention is described in a preferred embodiment in the following description with reference to the drawings, in which like numbers represent the same or similar elements and one or a plurality of such elements, as follows:

FIG. 1 shows an exemplary wireless network and is illustrated to show the operation of a preferred embodiment of the present invention.

FIG. 2 shows a high-level block diagram of a data processing system 210, which may be a high-level computer system, consistent with an embodiment of the invention with which the method, system and program of the present invention may advantageously be utilized.

FIG. 3 shows a block diagram of a software architecture for a threat entity detection system, in accordance with the preferred embodiment of the present invention.

FIG. 4 shows a block diagram representing entries in an entity catalog in one example of a preferred embodiment of the present invention.

FIG. 5 shows a flow diagram of the operation of entity detector 303, in accordance with a preferred embodiment of the present invention.

FIG. 6 shows a flow diagram of a process for creating and updating an entity profile database storing the profile information for each of the entities identified on the wireless network, in accordance with the preferred embodiment of the present invention.

FIG. 7 shows a flow diagram of a process for updating the entity visitation database in accordance with the preferred embodiment of the present invention.

FIG. 8 shows a flow diagram of the process of entity detection, in accordance with the preferred embodiment of the present invention.

FIG. 9 shows a flow diagram of the process for an entity notification function performed by entity notification service, in accordance with a preferred embodiment of the present invention.

FIG. 10 shows a flow diagram of the administrator notification function performed my administrator notification service, in accordance with a preferred embodiment of the present invention.

FIG. 11 shows a flow diagram of a system for enabling security settings in a remote router, in accordance with a preferred embodiment of the present invention.

FIG. 12 shows a flow diagram of a process for adding a new network member to the wireless network while security features are enabled, in accordance with a preferred embodiment of the present invention.

### DETAILED DESCRIPTION OF PREFERRED EMBODIMENTS

In a preferred embodiment, the present invention provides a system and method for providing a simple interface for controlling security features and maintaining security on a wireless network. The method and system automatically scans a wireless network using various protocols to build entity profile data for each detection on the network. Upon first detection of a new entity, the profile data is corrected and presented to the system user for classification as an authorized member of the network or as an unauthorized device or threat entity on the network. The system user can then define an automatic action to be taken at this point, and at any point in the future upon identification of the same threat entity being detected on the network. For example, a typical action could include notifying the threat entity of its detection through some type of network messaging protocol, or sending the threat continuous requests (i.e., bombarding) over the network to effectively eliminate the usefulness of its membership on the network. The method and system can further take action to enable security features on the network router to block the threat entities access to the network or to stop broadcasting the availability of the wireless network to prevent other threat entities from detecting and infiltrating the network. The function of such a system and methodology in a typical software environment is described below.

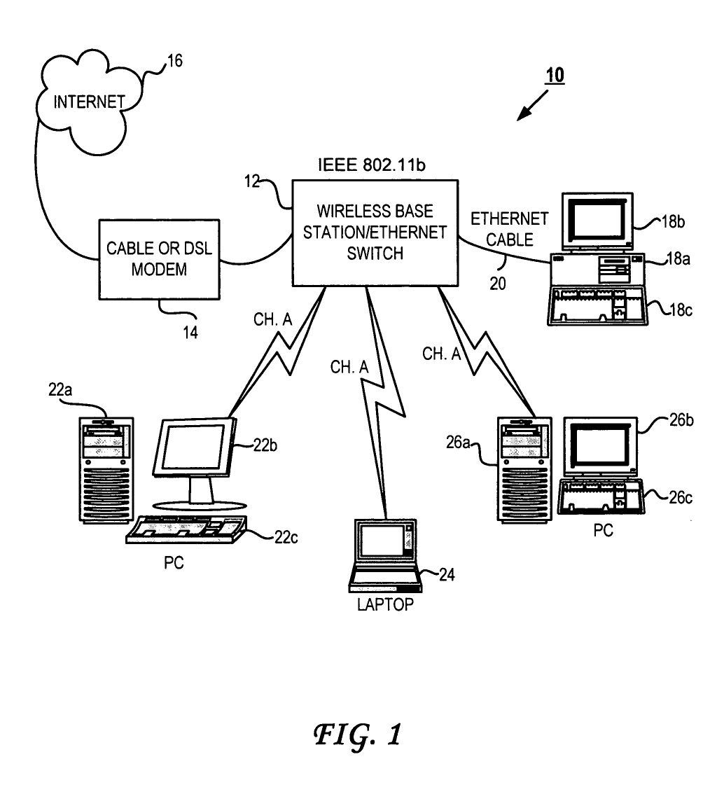

With reference now to the figures, and in particular with reference to FIG. 1, an exemplary wireless network is illustrated to show the operation of a preferred embodiment of the present invention. It should be emphasized that FIG. 1 simply shows an example of such a network and is not intended to in any way be limiting of the present invention and its capabilities. Accordingly, although most of the clients coupled together in communication through wireless devices in FIG. 1 are personal computers, it is emphasized that almost any type of electronic device or data processing system suitable for a communication over a wireless network can be included in such a network using the present invention. Further, while the exemplary system shown in FIG. 1 utilizes the IEEE 802.11b standard, the present invention is not in any way limited to communications using the IEEE 802.11b standards but instead, is applicable to almost any form of wireless communication.

The wireless system 10 of FIG. 1 includes a wireless access point 12 and wireless clients 18, 22, 24, 26. Wireless base station/Ethernet switch or router 12 is coupled through cable or DSL modem 14 to Internet 16. Wireless system 10 also includes personal computers (PCs) 18 and 26, laptop 24, and server 22. Server 22, laptop 24 and PC 26 employ wireless devices (not separately shown) that communicate with wireless base station/Ethernet switch 12 over a wireless “Channel A” using the IEEE 802.11b Standard. Also connected to wireless base station/Ethernet switch 12 is a PC 18 connected via an Ethernet cable 20 (hardwired). PCs 18, 26 and server 22, each have associated computer bases, monitors and keyboards 18a, 18b, 18c, 26a, 26b, 26c and 22a, 22b, 22c.

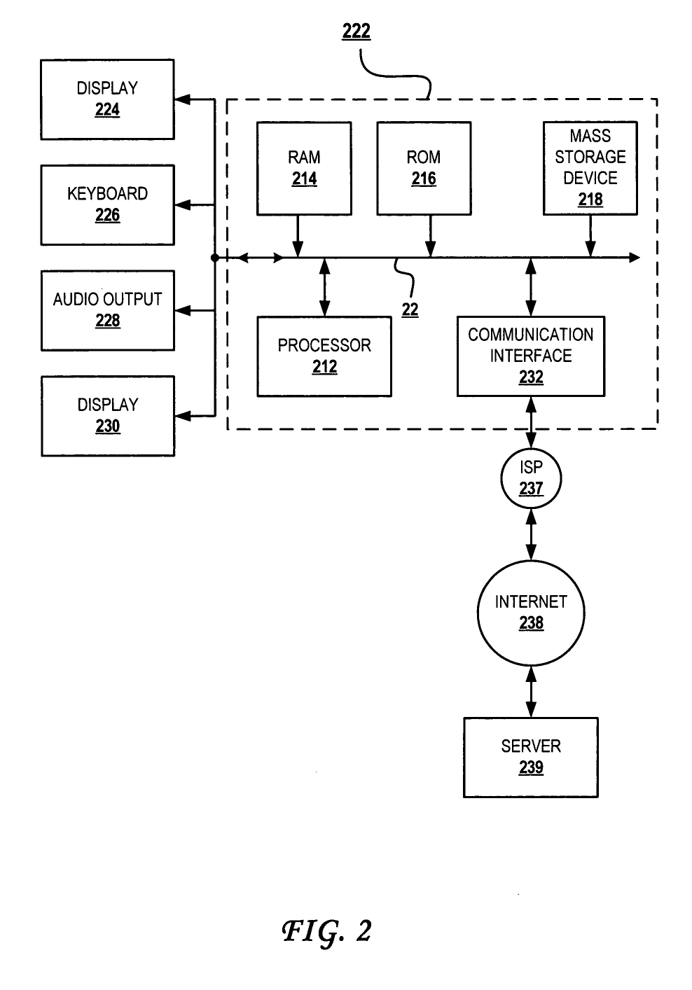

FIG. 2 shows a high-level block diagram of a data processing system 210, which may be a high-level computer system, consistent with an embodiment of the invention with which the method, system and program of the present invention may advantageously be utilized, and may be, for example, any of PCs 18, 26, server 22 or laptop 24. A computer system can be considered as three major components: (1) the application programs, such as a spreadsheet or word processing or graphics presentation application, which are used by the user; (2) the operating system that transparently manages the application's interactions with other applications and the computer hardware; and (3) the computer hardware comprising the processor, the memories or data storage, and the actual electronic components which manage the digital bits. The operating system has a kernel which, inter alia, controls the execution of applications, processes, and/or objects by allowing their creation, termination or suspension, and communication, schedules processes/objects of the same or different applications on the hardware, allocates memory for those objects, administers free space, controls access and retrieves programs and data for the user.

Data processing system or computer system 210 comprises a bus 222 or other communication device for communicating information within computer system 210, and at least one processing device such as processor 212, coupled to bus 222 for processing information. While a single CPU is shown in FIG. 2, it should be understood that computer systems having multiple CPUs could be used.

Processor 212 may be a general-purpose processor that, during normal operation, processes data under the control of operating system and application software stored in a dynamic storage device such as random access memory (RAM) 214 and a static storage device such as Read Only Memory (ROM) 216 and mass storage device 218, all for storing data and programs. The system memory components are shown conceptually as single monolithic entities, but it is well known that system memory is often arranged in a hierarchy of caches and other memory devices. The operating system preferably provides a graphical user interface (GUI) to the user. In a preferred embodiment, application software contains machine executable instructions that when executed on processor 212 carry out the operations and processes of the preferred embodiment described herein. Alternatively, the steps of the present invention might be performed by specific hardware components that contain hardwire logic for performing the steps, or by any combination of programmed computer components and custom hardware components.

Communication bus 222 supports transfer of data, commands and other information between different devices within computer system 210; while shown in simplified form as a single bus, it may be structured as multiple buses, and, may be arranged in a hierarchical form. Further, multiple peripheral components may be attached to computer system 210 via communication bus 222. A display 224 such as a cathode-ray tube display, a flat panel display, or a touch panel is also attached to bus 22 for providing visual, tactile or other graphical representation formats. A keyboard 226 and cursor control device 230, such as a mouse, trackball, or cursor direction keys, are coupled to bus 222 as interfaces for user inputs to computer system 210. In alternate embodiments of the present invention, additional input and output peripheral components may be added. Communication bus 222 may connect a wide variety of other devices (not shown) to computer system 210 and to other adapters connected to other devices such as, but not limited to, audio and visual equipment, tape drives, optical drives, printers, disk controllers, other bus adapters, PCI adapters, workstations using one or more protocols including, but not limited to, Token Ring, Gigabyte Ethernet, Ethernet, Fibre Channel, SSA, Fiber Channel Arbitrated Loop (FCAL), Ultra3 SCSI, Infiniband, FDDI, ATM, ESCON, wireless relays, USB, Twinax, LAN connections, WAN connections, high performance graphics, etc., as is known in the art.

Communication interface 232 provides a physical interface to a network, such as the Internet 238 or to another network server via a local area network using an Ethernet, Token Ring, or other protocol, the second network server in turn being connected to the Internet or Local Area Network. Internet 238 may refer to the worldwide collection of networks and gateways that use a particular protocol, such as Transmission Control Protocol (TCP) and Internet Protocol (IP), to communicate with one another. The representation of FIG. 2 is intended as an exemplary simplified representation of a high-end computer system, it being understood that in other data processing systems 210, variations in system configuration are possible in addition to those mentioned here.

The present invention may be provided as a computer program product, included on a machine-readable medium having stored thereon the machine executable instructions used to program computer system 210 and/or to a peripheral device for installation on a connected adapter to perform a process according to the present invention. The term “machine-readable medium” as used herein includes any medium, signal-bearing media or computer readable storage media that participates in providing instructions to processor 212 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patters of holes, a programmable ROM (PROM), an erasable PROM (EPROM), electrically EPROM (EEPROM), a flash memory, any other memory chip or cartridge, or any other medium from which computer system 210 can read and which is suitable for storing instructions. In the present embodiment, an example of nonvolatile media is storage device 218. Volatile media includes dynamic memory such as RAM 214. Transmission media includes coaxial cables, copper wire or fiber optics, including the wires that comprise bus 222. Transmission media can also, take the form of electromagnetic, acoustic or light waves, such as those generated during radio wave or infrared wireless data communications. Thus, the programs defining the functions of the preferred embodiment can be delivered to the data processing system 10 information on any machine-readable medium, which include, but are not limited to: (a) information permanently stored on non-write storage media, e.g., read only memory devices within either computer such as CD-ROM disks readable by CD-ROM; (b) alterable information stored on write-able storage media, e.g., floppy disks within a diskette drive or a hard-disk drive; or (c) information-conveyed to a computer by a telephone or a cable media network, including wireless communications. Such signal-bearing media, when carrying instructions that may be read by an adapter or a computer to direct the functions of the present invention, represent alternative embodiments.

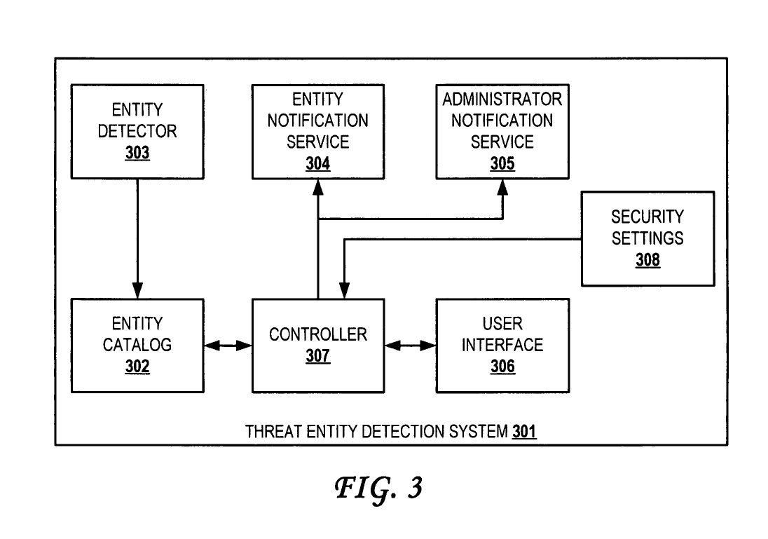

With reference now to FIG. 3, there is shown a block diagram of a software architecture for a threat entity detection system, in accordance with the preferred embodiment of the present invention. Threat entity detection system 301 is a software program executing within a PC or other data processing system, for example in any of PCs 18, 26, server 22 or laptop 24. The threat entity detection system 301 is comprised of an entity catalog 302, an entity detector 303, and entity notification service 304, administrator notification service 305, a user interface 306, interfacing with a local controller function 307, and security settings module 308. Threat entity detection system 301 operates on a continuous basis to detect any new entities joining the scanned network channel A.

As an example of the operation of the preferred embodiment of the present invention, threat entity detection system 301 is executing as a process of server 22. Threat entity detection system 301 operates on a continuous basis within server 22 to monitor wireless channel A and detect any new entities joining the scanned network of wireless base station/Ethernet switch 12. Upon detection of a new entity within the wireless network 10, entity detector 303 accessing entity catalog 302 and adds or updates an entry within entity catalog 302 that identifies the new entity and stores identifying information about the new entity.

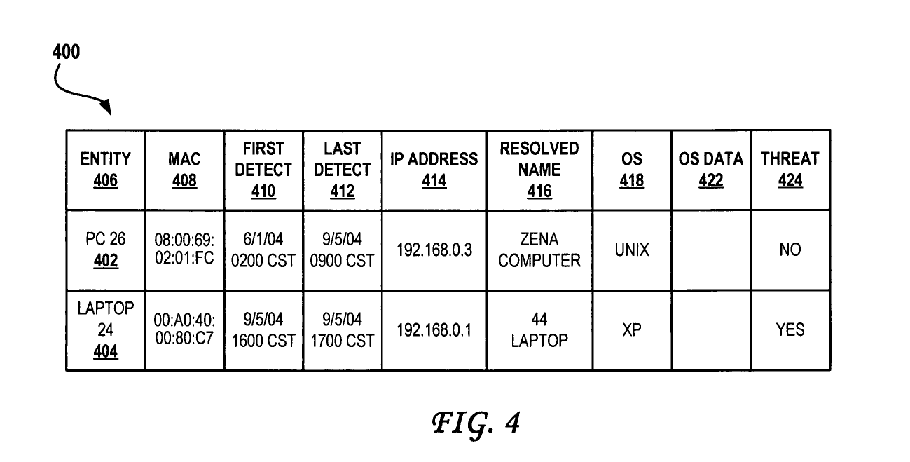

FIG. 4 shows a block diagram representing entries in an entity catalog in one example of a preferred embodiment of the present invention. As seen in FIG. 4, entity detector 303 in server 22 has detected PC 26 and laptop 24 on wireless network 10 and created entries for each within rows 402 and 404 of entity catalog 302. Each row 402, 404 contains columns of data identifying each entity 406 and specifying particular information 408-422 about the identified entity compiled by threat entity detection system 301. In particular, database 400 compiled by entity catalog 302 stores an entity identifier 406 (created by threat entity detection system 301), MAC address 408, date of first detection 410, date of last detection 412, IP address 414, resolved name 416, operating system (OS) 418, other operating system data 422, and a tag 424 set by threat entity detection system 301 indicating if the system user has indicated the entity is a threat or non-threat to the wireless network 10.

With reference back to FIG. 3, controller function 307 continuously monitors the entity catalog 302 and makes the determination if messages need to be dispatched to the entity notification service 304, the administrator notification service 305 or the user interface 306. Upon receipt of a dispatch from controller function 307, entity notification service 304 will attempt to notify the detected entity 406. Upon receipt of a dispatch from the controller function 307, the user interface 306 will update a visual display or audio notification to the system user accordingly. The user interface 306 will also dispatch messages received from the system user to the controller function 307 to modify entity classification and system configuration as described in more detail below.

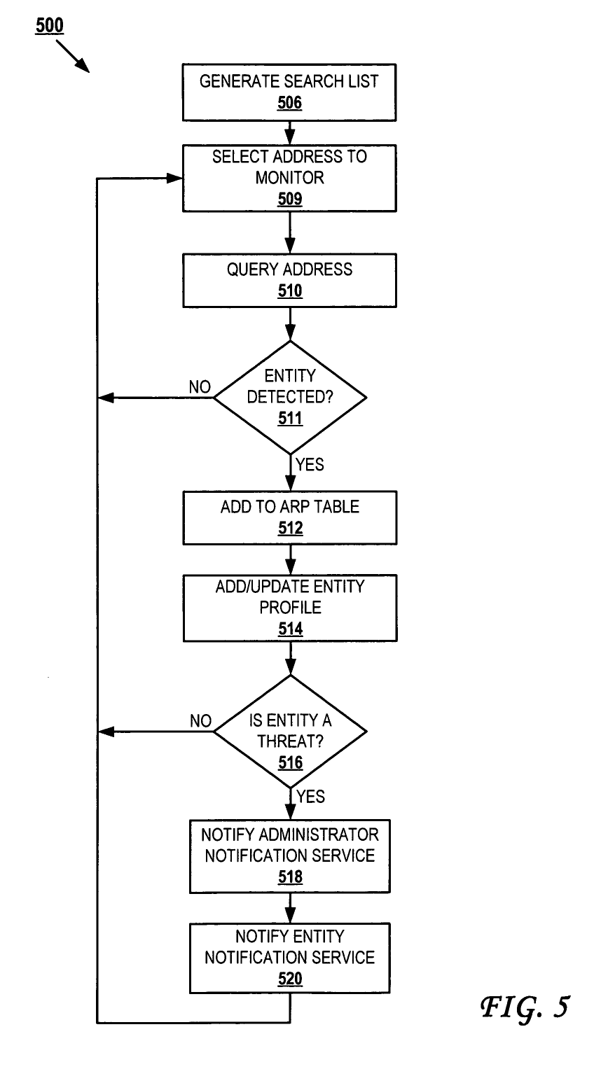

With reference now to FIG. 5, there is shown a flow diagram of the operation of entity detector 303, in accordance with a preferred embodiment of the present invention. Process 500 begins at step 506 when entity detector 303 generates a list of network addresses to scan on the wireless network 10. In a preferred embodiment, the network address list is set as the class C address space reserved for private networks of router 12, giving 252 possible addresses to scan in that space. For example, if server 22's IP address is 192.168.1.50, then addresses between 192.168.1.1 and 192.168.1.255 are scanned, minus the server's own address, the address of the router controlling the network segment, and the last address (255) which is a reserved broadcast address.

At step 509, entity detector 303 selects a next address from the search list to monitor. At step 510, the selected address is queried by sending an Address Resolution Protocol (ARP) request. This type of request is typically used to determine the physical address of a network member before forming a network packet, for example a Ping or an HTTP request. As each monitored address is contacted, a decision is made as seen at step 511 whether the address responded to the request. If there is no response to the query at step 510, the process returns to step 509, where the next address in the network address search list to monitor is selected. If the device at the address does respond to the request, the process proceeds to step 512, where entity detector 303 builds an ARP table by populating it with all internet protocol (IP) addresses on the network and each of the associated physical addresses called a DLC (Data Link Control) or a MAC (media access control) address. The IEEE 802.3 (Ethernet) and 802.5 (Token Ring) protocols specify that the MAC sub-layer must supply a 48 bit address represented as 12 digit hexadecimal digits that uniquely identifies the network device. The first portion of the MAC address identifies the vendor of the network device, the last portion identifies the unique identifier (ID) of the device itself. In the case of the 802.x protocols, the first 24 bits of the MAC address identify the vendor, and the last 24 bits identify the network card itself. This allows for up to 16.7 million unique card addresses.

The ARP table built at step 512 is populated with any physical addresses that respond in the network at step 510. ARP is used to build a host table listing the network protocol, the protocol's logical address, and the physical address (MAC) of that host. All hosts in a broadcast domain will passively listen to broadcast ARP packets, and will record information heard in these broadcast packets to its host table. Additional information included in the entity catalog 302 is collected by entity detector 303 by querying a domain name server (DNS) for a name for the identified IP addresses in the ARP table. This will generate a device name for the computer or other network device identified by that unique IP address.

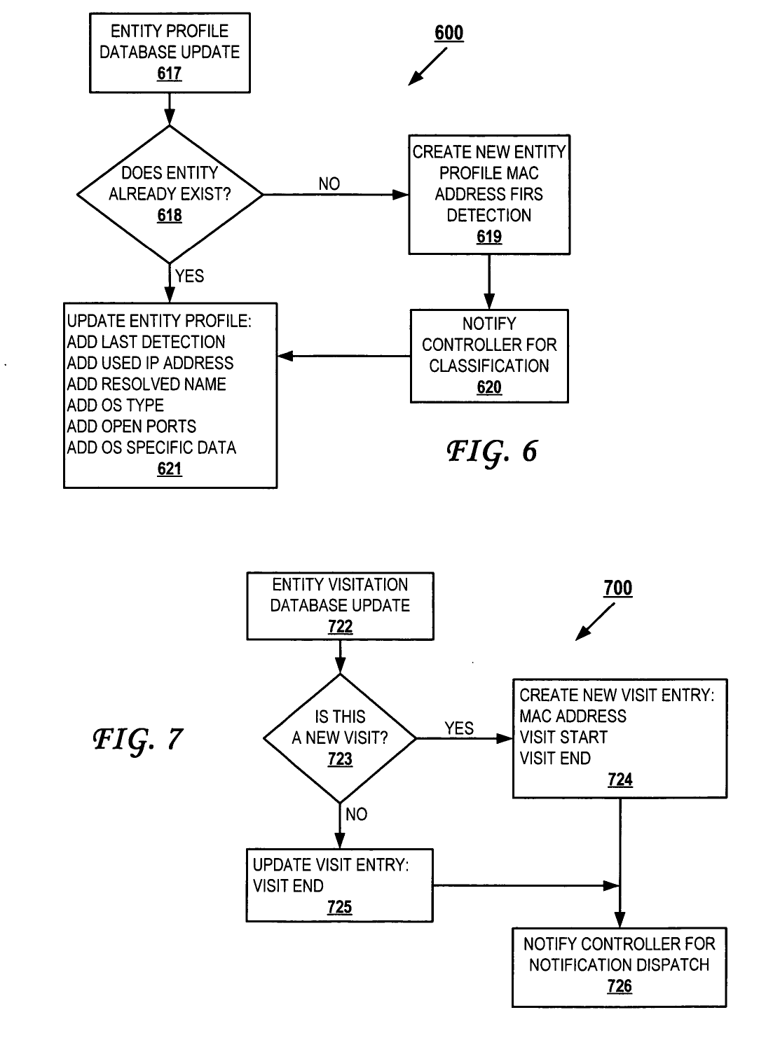

Returning to FIG. 5, at step 514, an entity profile is added or updated within the entity catalog 302 to reflect any new or updated information on each of the entities detected within the wireless network 10. This process of adding/updating entity profiles is described in detail in conjunction with FIG. 6. Process 500 then proceeds to step 516, where it is determined whether a newly-identified entity is considered a threat to the wireless network. Controller 307 notifies the system user at user interface 306 of the added or updated entry in entity catalog 302. The system user then provides input at user interface 306 to specify whether an entity on the network is considered a threat or non-threat to the wireless network. This input is communicated to controller 307, which sets the tag 424 in database 400 accordingly. At step 516, a determination that the entity is not a threat returns the process to step 509 and a determination that the entity is a threat, sends the process to steps 518 and 519, where the entity notification and system administrator services are notified that a threat entity exists on the wireless network. Step 518 is performed by entity detector 303 by notifying controller function 307 and requesting an administrative notification to administrator notification service 305. Step 518 is performed by entity detector 303 by notifying controller 307 and requesting an entity notification through entity notification service 304. Thereafter, the process returns to step 509 to select another address to query and analyze.

With reference now to FIG. 6, there is shown a flow diagram of a process for creating and updating an entity profile database storing the profile information for each of the entities identified on the wireless network, in accordance with the preferred embodiment of the present invention. The process begins at step 617 when the threat entity detection system 301 determines that a new entity or an update to an existing entity in the entity profile database 400 is required. At decision block 618, threat entity detection system 301 searches the database 400 to determine if an existing entry in the database exists for the entity. If not, the process proceeds to step 619 where a new entity profile is created in the database containing specifics relating to the entity including, but not limited to, the entity's MAC address and time of first detection on the wireless network. After the entity profile creation, controller 307 is notified at step 620 so that the entity can be classified by the system user through the user interface 306 as either a “threat” or a “non-threat” to the wireless network 10.

From step 618, in the event that a match for the entity is found within the database, or from step 620, the process proceeds to step 621 where the existing or newly-created entity profile is updated with visit specific information about the entity on the wireless network, including the time and date of the last detection, the IP address used by the entity, its resolved name, its OS type, open ports, and its OS specific data.

With reference now to FIG. 7, there is shown a flow diagram of a process for updating the entity visitation database in accordance with the preferred embodiment of the present invention. Upon detection on the wireless network 10 of an entity contained within the entity profile database 400, threat entity detection system 301 begins process 700 at step 722. At step 723, it is determined if the detected entity on the network is starting a new visit on the wireless network or is continuing an existing visitation by scanning the entity visitation database (not shown) for a current entry. If threat detection system 301 determines that the entity is starting a new visitation, it creates a new visit entry within the visitation database as seen at step 724. The information stored within the visitation database entry includes the MAC address, visit start time and visit end time. Thereafter, the process proceeds to step 726, where the controller 307 is notified for notification dispatch to the entity notification function 304 and the administrator notification function 305. If it is determined at step 723 that the entity is continuing an existing visitation, the process proceeds to step 725 where the time of “visit end” is updated to the current time. Thereafter, the process proceeds to step 726 to notify the controller 307 for notification dispatch.

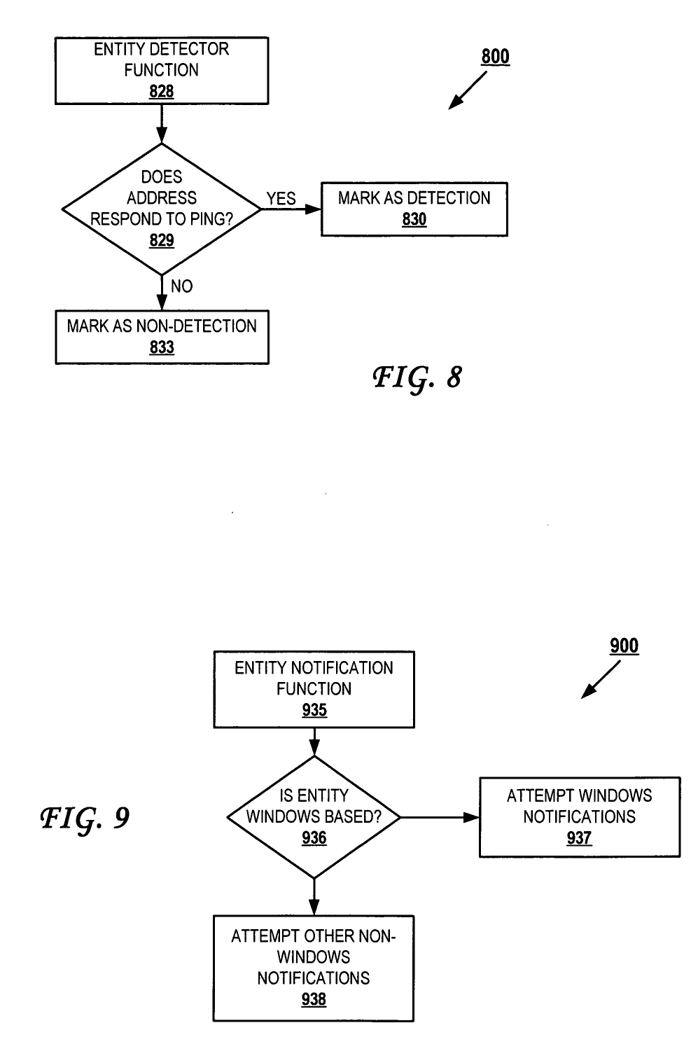

With reference now to FIG. 8, there is shown a flow diagram of the process of entity detection, in accordance with the preferred embodiment of the present invention. The process 800 begins at step 828 when the entity detector function 303 is invoked to implement step 510 as seen in FIG. 5. The process proceeds to decision block 829 where it is determined if the queried address responds to the request from threat entity detection system 301. If so, the process marks the entity as a detection in step 830 and if not, the queried address is marked as a non-detection of an entity at step 833. Thereafter, the process proceeds to step 511 as seen in FIG. 5.

With reference now to FIG. 9, there is shown a flow diagram of the process for an entity notification function performed by entity notification service 304, in accordance with a preferred embodiment of the present invention. The process 900 begins at step 935 when the entity notification function is invoked by entity notification service 304. The process then proceeds to step 936 where it is determined, based upon previous scan characteristics, whether the detected entity is a Windows-based system. If so, various user-defined notifications and actions are performed to attempt a Windows notification as seen at step 937. These Windows notifications could include, but are not limited to, NET SEND traffic flooding and remote shut-down procedures. If the decision at 936 regarding the entity's operating system as indeterminate, the process proceeds to step 938 where other user-defined notifications and actions are performed to attempt non-Windows notifications to the threat entity. These could include but are not limited to “syslog” messages, “smbclient” messages and traffic flooding. As examples of the notifications of steps 937, 938, a text message could be delivered to the threat entity stating, “You are an unauthorized user on a wireless network. You must log off of this network immediately.”

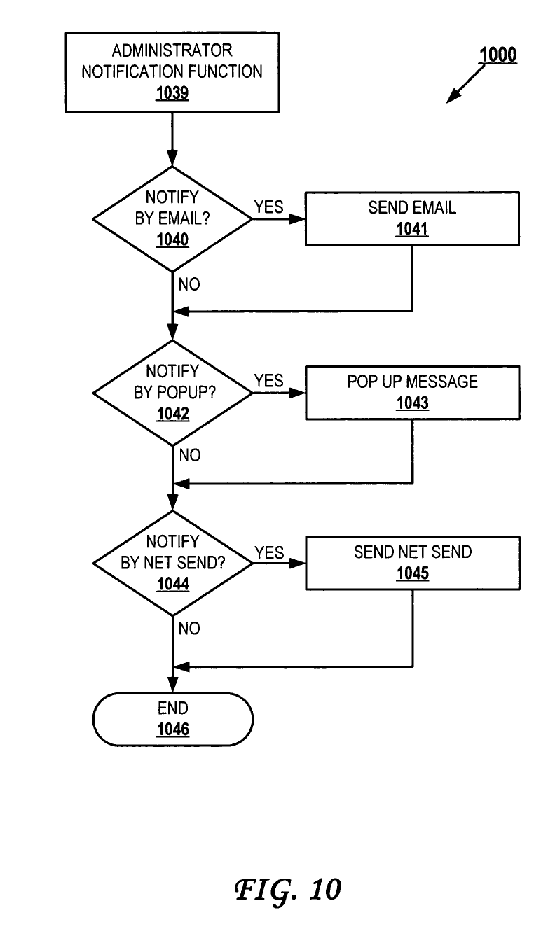

With reference now to FIG. 10, there is flow diagram of the administrator notification function performed my administrator notification service 305. The process 1000 begins at step 1039 where the administrator notification function is invoked by administrator notification service 305. At step 1040, a determination is made whether a user-defined preference has indicated that an email should be delivered to the system administrator. If so, an email is sent to the administrator at step 1041. At decision block 1042, a determination is made whether the system's user-defined preferences indicate that the system administrator should be notified by a “pop-up” type window. If so, the process proceeds to step 1043 where a pop-up message is delivered to the system administrator's user interface 306. At step 1044, a determination is made whether the user-defined preferences indicate that the system administrator should be notified by a “NET SEND” type of message. If so, the process proceeds to step 1045 where a “NET SEND” message is sent to the system administrator. Thereafter, the process ends at step 1046.

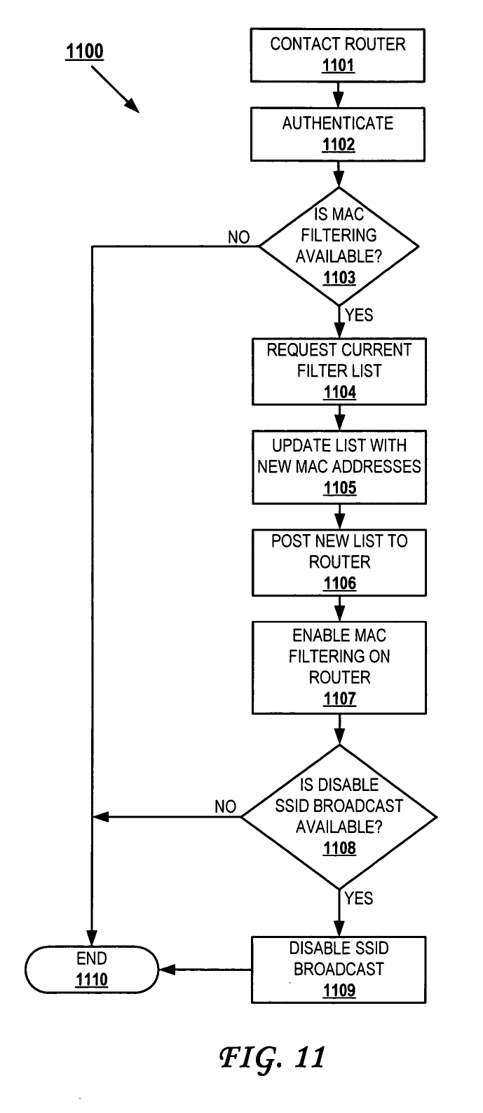

With reference now to FIG. 11, there is shown a flow diagram of a system for enabling security settings in a remote router, in accordance with a preferred embodiment of the present invention. Security settings module 308 initiates the process 1100 by contacting router 12, as seen at step 1101. Here, the security settings module would contact the router in charge of the network segment where the data processing system running threat detection system 301 resides. At step 1102, the computer running the threat detection system 301, for example server 22, authenticates itself with the contacted router 12. Thereafter, at decision block 1103, security settings module 308 determines whether MAC filtering is available on the contacted router 12. This is done through a standard query command to the router or based on the type of router and an accessible database of specifications for commercially available routers. If MAC filtering is not available on the contacted router, the process ends at step 1110. If MAC filtering is available, the process proceeds to step 1104 where security settings 308 requests the current MAC filter list loaded within the router 12. This is performed by sending an interface command to the router and the router responding with a list of MAC addresses currently in the filtering list on the router. At step 1105, security settings module 308 updates the list with any new MAC addresses identified by the user interface 306 at step 620 as a member of the wireless network. This would be determined by accessing database 400 to identify network entities tagged as non-threats. At step 1106, security settings 308 posts the updated list back to the router 12 using the standard interface commands for the particular brand of router used in the network. As step 1107, security settings 308 enables the MAC filtering on the router by setting the security setting on router 12 using the standard interface commands for the particular brand of router.

Thereafter, at step 1108, security settings 308 determines if a service set identifier (SSID) broadcast is available on the network's router. An SSID is a 32-character unique identifier attached to the header or packet sent over a LAN when a mobile device tries to connect to the wireless network. Because the SSID differentiates one LAN from another, all access points and devices attempting to connect to a specific WLAN must use the same SSID. A device will not be permitted to join the wireless network unless it can provide the unique SSID. Some wireless routers have the ability to disable broadcasting its SSID, thereby inherently restricted access to the wireless network to only those devices knowing the router's SSID. Based on a query response to the router or a search of a database of specifications for the particular brand of router, security settings 308 can determine if router 12 is capable of disabling its SSID broadcast. If not, the process ends at step 1110. If SSID broadcast disabling is available, the process proceeds to step 1109, where security settings 308 instructs router 12 through a standard interface command for the particular brand of router to disable its SSID broadcast. Thereafter, the process ends at step 1110.

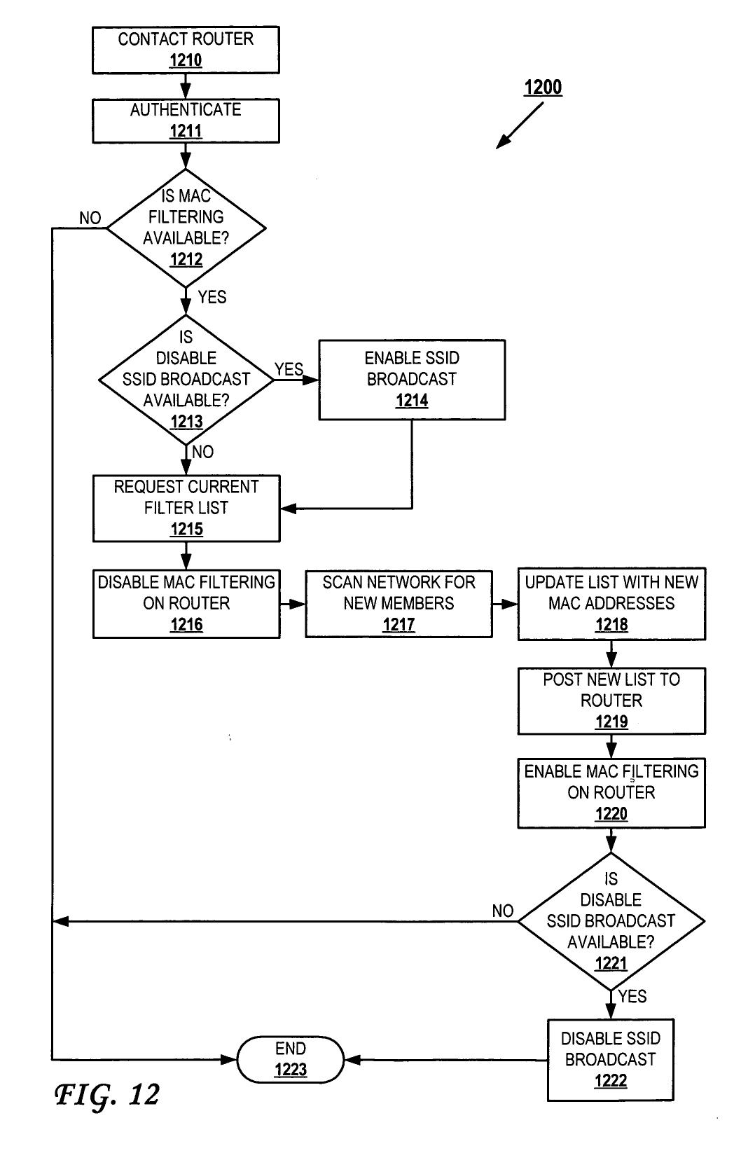

With reference now to FIG. 12, there is shown a flow diagram of a process for adding a new network member to the wireless network while security features are enabled, in accordance with a preferred embodiment of the present invention. Process 1200 is invoked by security settings 308 by contacting the router in charge of the network segment where the data processing system running threat detection system 301 resides, as seen at step 1210. At step 1211, the PC running the threat detection system 301, for example PC 18, authenticates itself with the contacted router 12.

Thereafter, at decision block 1212, security settings module 308 determines whether MAC filtering is available on the contacted router. This is done through a query request to the router or based on an accessible database of specifications for commercially available routers. If MAC filtering is available on the router, the process proceeds to step 1213, and if not the process ends at step 1223. At step 2313, security settings 308 determines if a service set identifier (SSID) broadcast is available on the network's router. If not, the process proceeds to step 1215. If SSID broadcast disabling is available, the process proceeds to step 1214, where security settings 308 instructs router 12 through a standard interface command for the particular brand of router to disable its SSID broadcast.

At step 1215, security settings 308 requests the current filter list loaded within the router 12. At step 1216, security settings 308 disable the MAC filtering on the router by issuing a standard interface command on the router. At step 1217, entity detector 303 performs a scan of the wireless network for new members in accordance with process 500. Thereafter, at step 1218, security settings module 308 updates the database 400 with any new MAC addresses identified by the user interface 306 at step 620 as a member of the wireless network. At step 1219, security settings 308 then posts the updated list back to the router 12 using the standard interface commands for the particular brand of router used in the network. As step 1220, security settings 308 then enables the MAC filtering on the router 12 by setting the security setting on router 12 using the standard interface commands for the particular brand of router.

Thereafter, at decision block 1221, security settings 308 determines if a service set identifier (SSID) broadcast is available on the network's router. If SSID broadcast disabling is available, the process proceeds to step 1222, where security settings 308 instructs router 12 through a standard interface command for the particular brand of router to disable its SSID broadcast. Thereafter, the process ends at step 1223.

1. A method comprising:
detecting entities accessing a wireless network;
identifying a detected entity is unauthorized on the wireless network;
enabling security settings within an access point to the wireless network to restrict the unauthorized entity's access to the wireless network.

2. A method according to claim 1, further including notifying the user when a previously-identified unauthorized entity accesses the network, circumventing any security measures taken to prevent unauthorized access to the network.

3. A method according to claim 1, where the network entities are identified by MAC addresses populated in an ARP table.

4. A method according to claim 1, where an action is taken in response to a network entity being identified as an unauthorized entity, including (1) sending the unauthorized entity a message over the network, or (2) filtering MAC addresses of entities on the network to prevent a unauthorized entity, identified by its MAC address, from accessing the network.

5. A method according to claim 1, wherein the detected entity is identified as unauthorized based upon user input.

6. A method according to claim 1, wherein the step of detecting entities accessing a wireless network is continually performed by repetitive scans of an address space of the wireless network.
